(19) United States
(12) Patent Application Publication
(10) Pub. No.: US 2015/0235425 A1
(43) Pub. Date: Aug. 20, 2015

(54) TERMINAL DEVICE, INFORMATION PROCESSING DEVICE, AND DISPLAY CONTROL METHOD

(71) Applicant: FUJITSU LIMITED, Kawasaki-shi (JP)

(72) Inventor: Susumu KOGA, Kawasaki (JP)

(73) Assignee: FUJITSU LIMITED, Kawasaki-shi (JP)

(21) Appl. No.: 14/600,530

(22) Filed: Jan. 20, 2015

(30) Foreign Application Priority Data
Feb. 14, 2014 (JP) 2014-026640

(51) Int. Cl. G06T 19/00; G06K 9/62

(52) U.S. Cl. CPC G06T 19/006; G06K 9/6202

(57) ABSTRACT

A terminal device includes: a memory; and a processor, wherein the processor is configured to recognize a reference object included in an input image, determine whether feature information of the input image used for recognizing the reference object includes feature information based on free area information or non-free area information set in association with identification information of the recognized reference object, and create an image in which content associated with the identification information is superimposed on the input image based on a result of the determination.

### CROSS-REFERENCE TO RELATED APPLICATION

This application is based upon and claims the benefit of priority of the prior Japanese Patent Application No. 2014-026640, filed on Feb. 14, 2014, the entire contents of which are incorporated herein by reference.

### FIELD

The embodiments discussed herein are related to a terminal device, and a display control method.

### BACKGROUND

There is known an augmented reality (AR) technology that displays content information in a superimposed manner on a portion of a captured image captured by an image pickup unit of a terminal device. Content provided by using the AR technology (hereinafter, referred to as “AR content”) has a display position set in a virtual space corresponding to a reality space for each piece of the AR content. Also, as a determination reference (a reference object) of a positional relationship between the terminal device and the AR content, an AR marker is used. The positional relationship between the AR marker and the terminal device is determined based on an image of the AR marker included in an image captured by the terminal device.

The AR content such as a superimposed image displayed based on the AR marker recognized by the terminal device includes not only one registered in advance by an operation of an administrator but also one registered by an operation of an operator or the like. With the operation of registration, the user such as the administrator or the operator may set the AR content in a relative position from the AR marker.

Related technologies are disclosed in Japanese National Publication of International Patent Application No. 2010-531089 and International Publication Pamphlet No. WO2005/119539.

As described above, in the conventional method, AR content is displayed based on recognition of an AR marker. Accordingly, when the AR marker is recognized, AR content is displayed regardless of a state when it is recognized. This indicates that even for a copied AR marker or an AR marker moved in an incorrect position, AR content associated with the AR marker is displayed. Also, in a case where the AR content is registered, it is difficult to check whether the AR marker is recognized in a position where the AR marker is originally to be placed (for example, on-site or the like).

### SUMMARY

According to an aspect of the invention, a terminal device includes: a memory; and a processor, wherein the processor is configured to recognize a reference object included in an input image, determine whether feature information of the input image used for recognizing the reference object includes feature information based on free area information or non-free area information set in association with identification information of the recognized reference object, and create an image in which content associated with the identification information is superimposed on the input image based on a result of the determination.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example schematic configuration of an information processing system;

FIG. 2 is a diagram illustrating an example functional configuration of a server;

FIG. 3 is a diagram illustrating an example functional configuration of a terminal device;

FIG. 4 is a diagram illustrating an example hardware configuration of the server;

FIG. 5 is a diagram illustrating an example hardware configuration of the terminal device;

FIGS. 6A and 6B are diagrams, each illustrating such an example that an AR marker is placed on a real object;

FIG. 7 is a flowchart illustrating example processing of setting a free area and AR content according to a first embodiment;

FIGS. 8A and 8B are diagrams, each illustrating a specific embodiment of setting a free area in the first embodiment;

FIG. 9 is a flowchart illustrating example processing of setting a free area and AR content according to a second embodiment;

FIG. 10A is a diagram illustrating an image shooting direction in a terminal device 12 in the second embodiment;

FIG. 10B is a diagram illustrating an example setting sate in the second embodiment;

FIG. 11 is a flowchart illustrating example processing of setting a free area in a third embodiment;

FIG. 12A illustrates an example data management table;

FIG. 12B is a diagram illustrating an example AR content management table;

FIG. 13A is a diagram illustrating an example marker ID management table;

FIG. 13B is a diagram illustrating an example AR content management table;

FIG. 13C is a diagram illustrating an example determination position information management table;

FIG. 13D is a diagram illustrating an example free area information management table;

FIG. 13E is a diagram illustrating an example determination objection position information management table;

FIG. 14A is a diagram illustrating coordinate values of an AR marker;

FIG. 14B is a diagram illustrating a coordinate value of AR content;

FIG. 14C is a diagram illustrating coordinate values of a non-free area;

FIG. 14D is a diagram illustrating example feature points of the object in a recognition object position information management table;

FIG. 15 is a flowchart illustrating example display control processing;

FIGS. 16A and 16B are diagrams, each illustrating an example of navigating an image shooting position;

FIG. 17 is a diagram illustrating a determination example using a determination object;

FIG. 18 is a diagram illustrating an example display screen of a terminal device; and

FIGS. 19A and 19B are diagrams, each illustrating an example of displaying the content for the free area.

### DESCRIPTION OF EMBODIMENTS

Hereinafter, embodiments are described based on drawings.

<Example Schematic Configuration of Information Processing System>

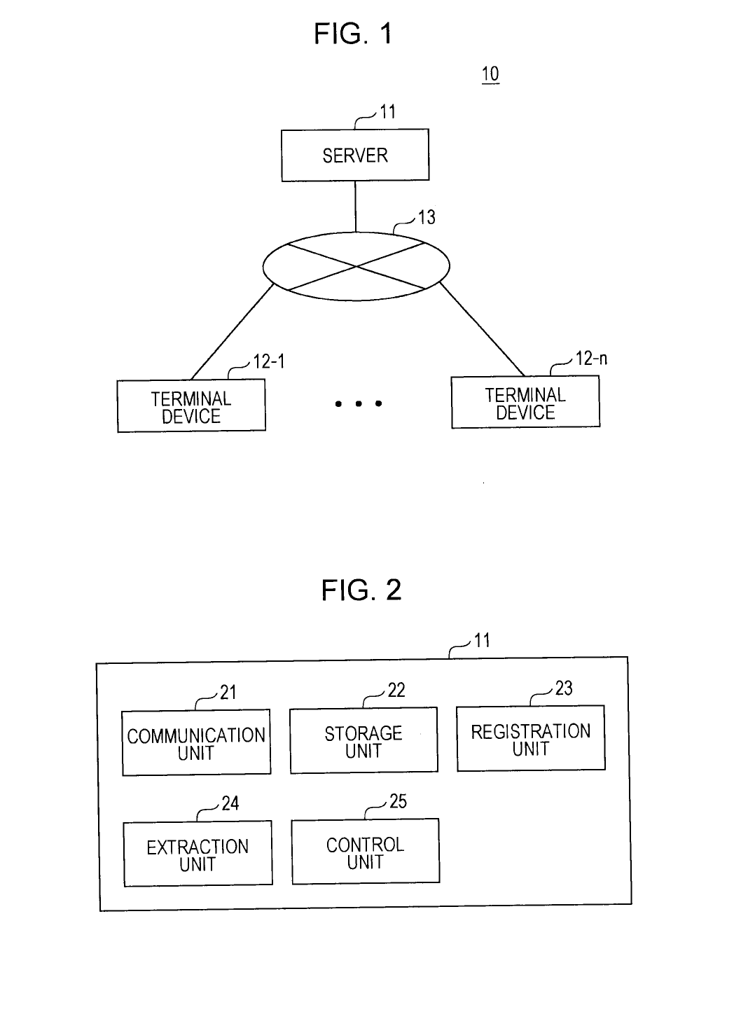

FIG. 1 is a diagram illustrating an example schematic configuration of an information processing system. An information processing system 10 illustrated in FIG. 1 has a server 11 as an example information processing device, and one or multiple terminal devices 12-1 to 12-n (hereinafter, referred collectively to as “a terminal device 12” as appropriate). The server 11 and the terminal device 12 are connected with each other via, for example, a communication network 13 in a state of being capable of transmitting and receiving data.

The server 11 manages AR markers, as example reference objects, and determination conditions for pieces of AR content respectively associated with the AR markers and display control of the terminal device 12 (for example, a free area, feature information on a determination object and the like). Here, for example, the AR marker is a mark to designate contents of various pieces of content information, such as AR content and positional information to be displayed. For example, the AR marker is an image in which a predetermined pattern, a character pattern, or the like is formed in a predetermined area, like a two-dimensional barcode, for example, but it is not limited to this.

For example, the AR content is model data of a three-dimensional object or the like, which is placed on a three-dimensional virtual space corresponding to a reality space, and is superimposed information which is displayed on an image captured by the terminal device 12, for example, in a superimposed manner. Also, the AR content is displayed in a position set by relative coordinates from the AR marker included in the captured image, for example. The AR content according to the embodiment is associated with the AR marker and the like, for example, and includes various modes, for example, such as a text, icon, animation, mark, pattern, image, movie, and the like. Also, the AR content is not limited to one to be displayed and outputted and may be information such as voice, for example.

Also, the server 11 manages the free area in the captured image based on a set position on the reality space of the AR marker set by the terminal device 12 and an image shooting position of the terminal device 12. The free area is an area to display the AR content. A user such as an administrator or an operator causes the AR content, such as operation procedures or notices for a target object in the short image associated with the AR marker, to be displayed in the set free area.

Also, in the embodiment, the free area is used for determining whether the terminal device 12, for example, captures an AR marker from a proper position. The free area is area information which is defined by relative coordinates from the AR marker, for example, and includes information indicating a feature of the area (for example, feature point information, brightness information, and the like), but it is not limited to that. When it is determined as a result of the determination using the feature information such as the free area that the terminal device 12 captures the AR marker from a proper position, the AR content corresponding to the AR marker is registered or control of displaying the registered AR content is performed.

In the embodiment, a non-free area, but not a free area, may be set in the above image and the set non-free area is used to determine whether registration or display of the AR content is performed. For example, the non-free area is an area which is set so as not to be hidden with the superimposed display of the AR content and an area in which a real object corresponding to the contents of the AR content or the like exists. Also, in the embodiment, the determination may be performed using the feature information of the object using a real object existing in the image as a determination object. These determination conditions may be selected according to an AR marker or the like or may be obtained by combining multiple conditions.

For example, when the server 11 receives information relating to the captured AR marker from the terminal device 12 (for example, a marker ID), the server 11 transmits determination conditions such as the AR content or a free area corresponding to the marker ID to the terminal device 12. The embodiment is of course not limited to this. For example, such configuration is also possible that the server 11 receives the marker ID, positional information, captured image, or the like from the terminal device 12 and extracts free area information corresponding to the marker ID on the server 11 side, and then determines the capturing position of the terminal device 12 or the like and transmits the AR content associated with the marker ID to the terminal device 12 based on the determination result.

The server 11 may be a personal computer (PC), for example, but is not limited to this. For example, the server 11 may be a cloud server or the like, which is configured by a cloud computing having one or more information processing devices.

The terminal device 12 registers the AR content corresponding to the AR marker, and determines whether the AR marker is captured in a proper place based on the captured AR marker or a free area, and displays the AR content corresponding to the AR marker on a screen according to the determination result. For example, the terminal device 12 recognizes the AR marker (hereinafter, recognizing the AR marker is referred to as “marker recognition”) included an image which is captured by an image pickup unit such as a built-in camera or the like.

Also, based on the AR marker recognized by the marker recognition and the free area (or non-free area) set in association with the AR marker, the terminal device 12 determines whether the set feature information is included. In addition, the terminal device 12 performs control (for example, control on whether output is performed or control on output contents) of outputting superimposed information such as the AR content associated with the AR marker or the like according to the determination result. The terminal device 12 may also transmit the information such as the AR marker recognized by the marker recognition or position information to the server 11 and perform corresponding output control based on the determination result performed on the server 11 side.

In the marker recognition in the embodiment, there is a possibility that a same free area is accidentally set even when the AR marker is captured in a different place when it is set only by determining the free area when the AR marker is captured from one angle (for example, the AR marker's front direction). In this case, it is determined that the AR marker is captured in a correct position in spite of the fact that conditions are not desirable, and the AR content associated with the AR marker may become possible to be displayed.

For this reason, in the embodiment, the terminal device 12 may perform determination using the AR marker and the free area on an image captured from multiple angles (for example, three angles, or the like). For example, the terminal device 12 may differently use an image shooting direction in one angle or multiple angles according to particularities of the free area information (for example, the position, size, and range of the free area or the number of the free areas in an image) or the like.

For example, the terminal device 12 is a tablet terminal, a smartphone, a personal digital assistant (PDA), a laptop PC, or the like. However, it is not limited to these, but may be a communication terminal such as a game machine, a mobile telephone, or the like, for example.

For example, the communication network 13 is the Internet, a local area network (LAN), or the like. However, it is not limited to this. Also, the communication network 13 may be wired or wireless, or be a combination thereof.

The information processing system 10 illustrated in FIG. 1 has the configuration of one server 11 and n terminal devices 12. However, the configuration is not limited to this, and it may have multiple servers, for example.

<Function Configuration Example of Server 11>

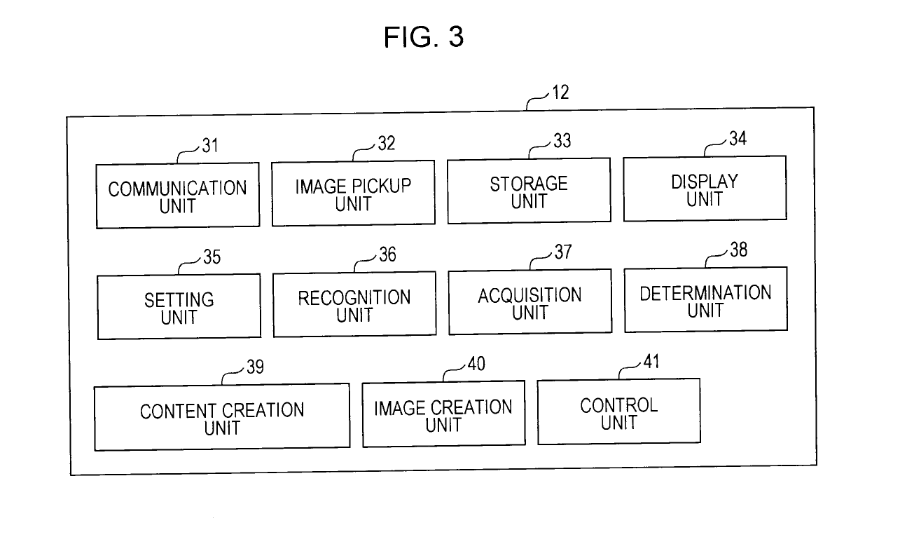

Hereinafter, an example functional configuration of the server 11 is described by using the drawing. FIG. 2 is a diagram illustrating an example functional configuration of a server. The server 11 has a communication unit 21, a storage unit 22, a registration unit 23, an extraction unit 24, and a control unit 25.

The communication unit 21 performs reception and transmission of data between the terminal device 12 and other computers through a communication network 13. The communication unit 21 receives a request to register the AR content or the like and determination conditions to control display of the AR content registered in association with the AR marker, a free area (or non-free area), or the like. In addition, the communication unit 21 receives determination conditions of the registered AR marker (for example, a marker ID) or the like and transmits the corresponding determination conditions and the AR content to the terminal device 12.

The storage unit 22 stores various pieces of information desired for the display control processing in the embodiment (for example, a marker ID management table, an AR content management table, a free area information management table, a determination position information management table, a determination objection position information management table, and the like). The storage unit 22 stores setting information created when the AR content is created in the terminal device 12, and determination conditions such as free area (or not-free area) information set for each of the AR markers, the AR content, the determination object information, the marker coordinate value information for designating a determination position, and the like.

The registration unit 23 registers various pieces of registration information such as the AR content obtained from the terminal device 12. For example, the registration unit 23 registers the identification information (marker ID) identifying an AR marker, the determination conditions set for the marker ID, and the AR content information set for the marker ID in association with one another. The registered information is stored in the storage unit 22.

The extraction unit 24 refers to the storage unit 22 based on the identification information (marker ID) obtained from the terminal device 12, and extracts the corresponding determination conditions and the AR content information. The determination conditions, the AR content, and the like, which are extracted by the extraction unit 24, are transmitted to the terminal device 12 which transmitted the marker ID through the communication unit 21.

It is to be noted that when the position information and the like is acquired in addition to the marker ID from the terminal device 12, the extraction unit 24 may determine whether the AR marker is an AR marker captured in a proper position based on the determination condition associated with the marker ID. For example, when a reference object (for example, an AR marker) included in an input image is recognized by the terminal device 12, the extraction unit 24 determines whether the feature information of the input image used for recognizing the AR marker includes feature information based on the free area information or the non-free area information, which is set for the recognition information of the recognized reference object. For example, in a case where it is determined that it is captured in a proper position, based on the determination result, the extraction unit 24 may perform processing of transmitting the AR content information associated with the marker ID to the terminal device 12. The control unit 25 controls each of entire components in the server 11. For example, the control unit 25 performs processing of causing the communication unit 21 to transmit and receive various pieces of information, the storage unit 22 to store data, the registration unit 23 to register the AR content and the determination conditions, and the extraction unit 24 to extract the AR content and the determination conditions, but the contents of controls performed by the control unit 25 are not limited to these.

<Example Functional Configuration of Terminal Device 12>

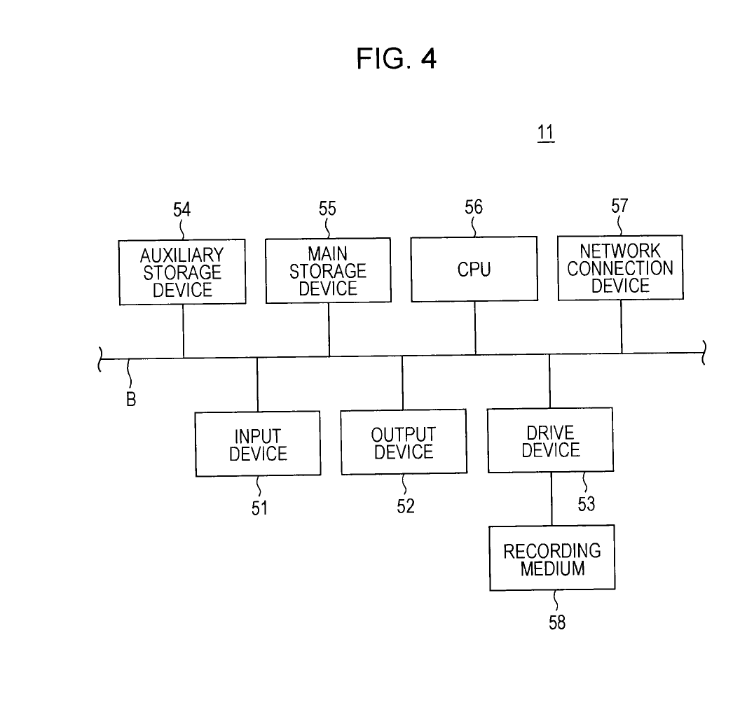

Hereinafter, an example functional configuration of the terminal device 12 is described by using the drawing. FIG. 3 is a diagram illustrating an example functional configuration of a terminal device. The terminal device 12 has a communication unit 31, an image pickup unit 32, a storage unit 33, a display unit 34, a setting unit 35, a recognition unit 36, an acquisition unit 37, a determination unit 38, a content creation unit 39, an image creation unit 40, and a control unit 41.

The communication unit 31 performs transmission and reception of data between the server 11 and other computers through the communication network 13. For example, the communication unit 31 transmits various pieces of setting information such as the determination conditions such as the AR content information associated with the AR marker and the free area (non-free area) information to the server 11. Also, the communication unit 31 transmits the marker ID recognized by the marker recognition to the server 11 and receives the determination condition, the AR content, and the like, which correspond to the transmitted marker ID.

The image pickup unit 32 captures an image with a preset frame. The image pickup unit 32 outputs the captured image to the control unit 41 and stores it in the storage unit 33.

The storage unit 33 stores various pieces of information (for example, a data management table, an AR content management table, and the like) desired for output control in the embodiment. For example, the storage unit 33 stores the AR marker at the time of registering the AR content, the AR content associated with the AR marker, the free area, the determination position, the determination object information, and the like. Also, the storage unit 33 temporarily stores information of marker management information (for example, the ID or position of the currently-recognized AR, and the like).

Also, the storage unit 33 stores the free area (non-free area) information set when the AR marker and the AR content are associated with each other (authoring), information relating to a determination object, determination state (how much the determination has been currently carried out) of the free area (non-free area), and the like. It is to be noted that these pieces of the information include not only information set by the terminal device 12 but information acquired from the server 11. Also, the information at the time of setting may be deleted after being transmitted to the server 11.

Based on the determination result obtained by the determination unit 38, the display unit 34 displays a screen in which the AR content is registered in a captured image created by the image creation unit 40, a superimposed image in which the registered content is superimposed on the captured image, other various kinds of setting images, and the like. Also, the display unit 34 may display a navigation frame to navigate a shooting position of the AR marker when the user performs the marker recognition. In addition, when the display unit 34 is a touch panel, the display unit 34 may acquires touched position coordinates on the touch panel.

After the AR marker is read, the setting unit 35 sets what kind of AR content is displayed in which position for that AR marker. Also, as the feature information, the setting unit 35 may set the free area (or non-free area), position information, information relating to the determination object, and the like, but the setting contents are not limited to these.

The recognition unit 36 recognizes a reference object (for example, an AR marker) included in the input image. For example, the recognition unit 36 performs image recognition on the captured image obtained by the image pickup unit 32, and obtains identification information of the AR marker and an object (a target object) on the reality space from the recognized result. Also, the recognition unit 36 acquires the position (coordinates) of the AR marker from the image pickup unit 32 or acquires the identification information (marker ID) of the AR marker. It is to be noted that there is such a case in the embodiment that a same piece of identification information is obtained from multiple reference objects (AR markers).

In the embodiment, for example, an AR marker is given to an object (a target object) on the reality space included in the captured image, so that a method using the object, operation procedures, notices, and the like may be displayed in a superimposed manner on the captured image as the AR content associated with the identification information of the AR marker.

It is to be noted that a reference object in the embodiment is not limited to the AR marker, but may use an object registered in advance as a reference object. In this case, the recognition unit 36 recognizes the registered object from the input image and acquires the identification information corresponding to the recognized object.

The acquisition unit 37 acquires feature information (first feature information) within an image area defined by the coordinates using the target object as a reference, which is associated with the marker ID read by the recognition unit 36. The first feature information is information set by the setting unit 35, and includes, for example, the free area information, the non-free area information, and the information corresponding to the determination conditions for the determination object. However, the first feature information is not limited to these. Also, the feature information may be caused to data.

For example, the acquisition unit 37 recognizes the AR marker, the object set in the free area (non-free area), and the termination object used for determination performed by the determination unit 38 by using an object recognition method such as a feature extraction, a brightness difference extraction, and the like. It is to be noted that the acquisition unit 37 may store the AR marker or a template defining a shape of the object in the storage unit 33 in advance, and recognize the AR marker or the object by performing the matching with the template. Also, the acquisition unit 37 may acquire a maximum value and a minimum value of brightness in a predetermined area of the image, and recognize the object from the feature quantity in the area based on a difference (brightness difference) between the maximum value and the minimum value. Also, the acquisition unit 37 may acquire an ID to identify the recognized AR marker and position and rotation (angle) information of the marker. It is to be noted that the acquisition unit 37 may perform acquisition processing after the recognition processing is performed by the recognition unit 36, or may perform the operation in different timing. Also, the image recognized by another terminal device is used, so that the acquisition unit 37 may acquire feature information.

The determination unit 38 determines whether the feature information of the input image used for recognizing the reference object (for example, the AR marker) obtained by the recognition unit 36 and the acquisition unit 37 includes feature information based on the free area information or the non-free area information, which is set in association with the recognized reference object. For example, the determination unit 38 determines whether the feature obtained from the captured image captured by the image pickup unit 32 matches the feature (determination conditions) indicated in the first feature information. For example, the determination unit 38 may acquire the AR marker of the feature points of the object from the acquisition unit 37 and determine whether the AR marker is captured in a proper position by performing matching determination based on the acquired feature points. However, the determination unit 38 is not limited to this. Determining whether the AR marker is captured in a proper position may be rephrased by determining whether the AR content associated with the AR marker is allowed to be displayed on the screen.

The content creation unit 39 creates the AR content displayed in association with the AR marker based on the determination result obtained by the determination unit 38. The AR content is displayed in a predetermined position in a free area set in advance, for example. It is to be noted that position information may be obtained by converting the points designated by the user on the screen through the content creation unit 39 into a marker coordinate system using the AR marker as a reference, but it is not limited to this.

When it is determined as a result of the determination processing using the AR marker or the free area that the AR content may be displayed, the image creation unit 40 creates a superimposed image (synthesized image) by superimposing the AR content corresponding to information of a reality space image. For example, the image creation unit 40 may display the AR content with a relative position from the AR marker on the screen, but is not limited to this.

The control unit 41 controls entre processing in each of the components included in the terminal device 12. The control unit 41 performs processing of causing the image pickup unit 32 to capture an image, the display unit 34 to display various pieces of information on the screen, and the setting unit 35 to perform various kinds of setting relating to output control in the embodiment.

Also, the control unit 41 performs processing of causing the setting unit 35 to perform various kinds of setting relating to the display control, the recognition unit 36 to recognize various pieces of information included in the captured image, the acquisition unit 37 to acquire the feature information included in the image, the determination unit 38 to determine based on the features of the image area and the determination conditions, the content creation unit 39 to create the AR content, and the image creation unit 40 to create a superimposed image.

<Example Hardware Configuration of Server 11>

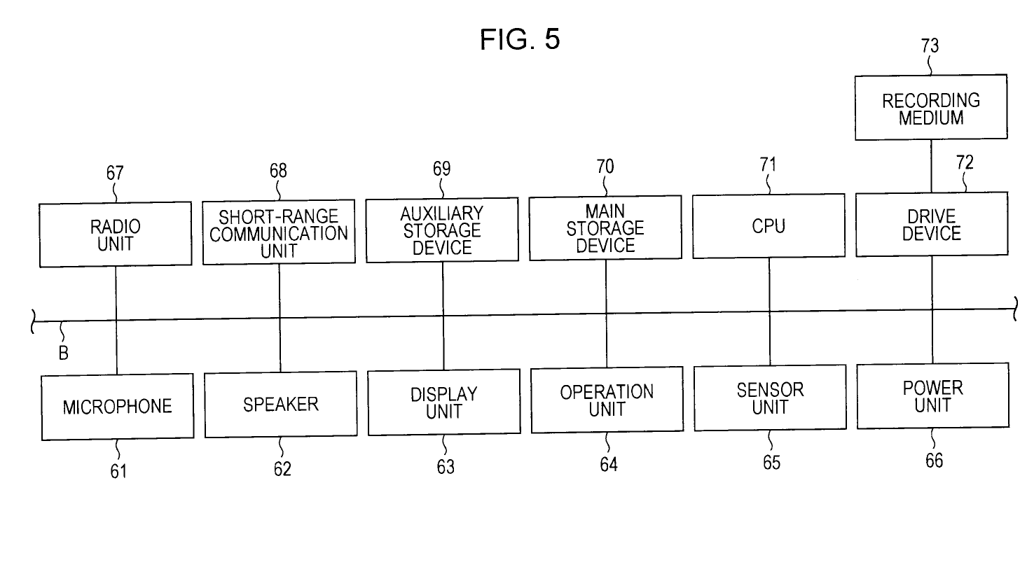

Hereinafter, an example hardware configuration of the server 11 is described by using the drawing. FIG. 4 is a diagram illustrating an example hardware configuration of the server 11. In the example of FIG. 4, the server 11 has an input device 51, an output device 52, a drive device 53, an auxiliary storage device 54, a main storage device 55, a central processing unit (CPU) 56, and a network connection device 57, which are connected with one another through a system bus B.

The input device 51 has a keyboard and a pointing device such as a mouse, which are operated by the user or the like, and a voice input device such as a microphone to accept inputs of an instruction to execute a program, various pieces of operation information, information for activating software and the like, from the user or the like.

The output device 52 has a display to display various kinds of windows and data and the like which are desired for operating the computer main unit (server 11) to perform processing in the embodiment. The output device 52 may display the execution progress, result, and the like of the program by a control program included in the CPU 56.

Here, for example, in the embodiment, an execution program to be installed in the computer main unit is provided by a recording medium 58 or the like. The recording medium 58 is capable of being set in the drive device 53. Based on a signal from the CPU 56, the execution program stored in the recording medium 58 is installed in the auxiliary storage device 54 from the recording medium 58 through the drive device 53.

For example, the auxiliary storage device 54 is a storage device such as a hard disk drive (HDD) or a solid state drive (SSD) or the like. Based on a control signal from the CPU 56, the auxiliary storage device 54 stores the execution program (display control program) in the embodiment, a control program provided in the computer, and the like and performs input and output as appropriate. Based on a control signal from the CPU 56, the auxiliary storage device 54 may read information desired from the various pieces of the stored information and write the information.

The main storage device 55 stores the execution program and the like, which are read by the CPU 56 from the auxiliary storage device 54. The main storage device 55 is a read only memory (ROM), a random access memory (RAM), or the like. CPU is also call a processor.

Based on a control program such as an operating system (OS) and the execution program stored in the main storage device 55, the CPU 56 achieves processing by controlling processing the entire computer, such as various operations and data input and output with each hardware configuration unit. The various pieces of information desired in executing the program may be acquired from the auxiliary storage device 54 and store the execution result and the like.

Specifically, for example, based on the program execution instruction or the like, which is obtained from the input device 51, the CPU 56 causes the program installed in the auxiliary storage device 54 to be executed, so as to perform processing corresponding to the program on the main storage device 55. For example, the CPU 56 causes the display control program to be executed, so as to perform processing of causing the registration unit 23 to register the feature information such as the AR content or the determination conditions (for example, the free area, non-free area, and determination object) used for determining whether the AR content is outputted, the extraction unit 24 to extract various pieces of information, and the control unit 25 to perform output control. The processing contents in the CPU 56 are not limited to the above contents. The contents executed by the CPU 56 are stored in the auxiliary storage device 54 or the like as appropriate.

The network connection device 57 performs communications between the terminal device 12 and other external devices through the communication network 13. Based on a control signal from the CPU 56, the network connection device 57 connects with the communication network 13 or the like and acquires the execution program, software, setting information, and the like from the external device or the like. Also, the network connection device 57 may provide an execution result obtained by executing a program to the terminal device 12 and the like or may provide the execution program itself in the embodiment to the external device and the like.

The recording medium 58 is a computer readable recording medium in which the execution program and the like are stored. For example, the recording medium 58 is a semiconductor memory such as a flash memory or a movable recording medium such as CD-ROM or DVD, but is not limited to this.

The execution program (for example, the display control program or the like) is installed in the hardware configuration illustrated in FIG. 4, so that the display control processing and the like in the embodiment become achievable with the cooperation of hardware resources and software.

<Example Hardware Configuration of Terminal Device 12>

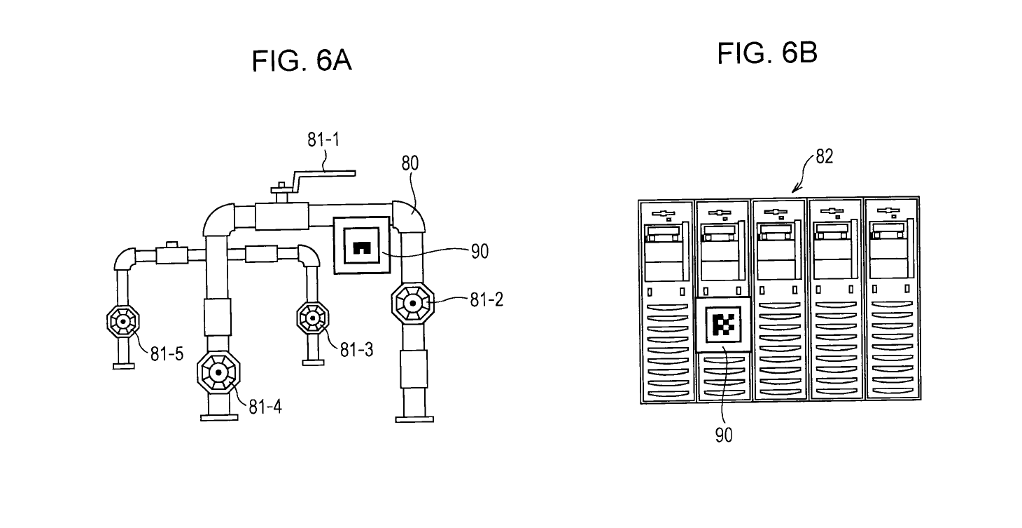

Hereinafter, an example hardware configuration of the terminal device 12 is described by using the drawing. FIG. 5 is a diagram illustrating an example hardware configuration of the terminal device. In the example of FIG. 5, the terminal device 12 has a microphone (hereinafter referred to as a “mic”) 61, a speaker 62, a display unit 63, an operation unit 64, a sensor unit 65, a power unit 66, a radio unit 67, a short-range communication unit 68, an auxiliary storage device 69, a main storage device 70, a CPU 71, and a drive device 72, which are connected with one another through a system bus B.

The mic 61 inputs voice generated by the user or another sound. The speaker 62 outputs voice of another party or outputs sound such as incoming call sound. For example, the mic 61 and the speaker 62 may be used when talking with another party with a call function or the like, but is not limited to this and may be used for input and output of information by voice.

The display unit 63 displays a screen set by the OS or the various kinds of applications to the user. Also, the display unit 63 may be a touch panel display or the like. In that case, the display unit 63 has a function as an input unit.

For example, the display unit 63 is a display such as a liquid crystal display (LCD) or an organic electro luminescence (EL) display.

The operation unit 64 is an operation button displayed on the screen of the display unit 63 or an operation button provided outside the terminal device 12. For example, the operation button may be a power button or a volume adjustment button, or may be operation keys for character input, which are arrayed in a predetermined order.

For example, the user performs a predetermined operation on the screen of the display unit 63 or presses the operation button, so that a touch position on the screen is detected by the display unit 63. Also, the display unit 63 may display an application execution result, content, an icon, a cursor, and the like on the screen.

The sensor unit 65 detects an operation at some time point or continuous operation of the terminal device 12. For example, the sensor unit 65 detects a tilt angle, acceleration, direction, position, and the like of the terminal device 12, but it is not limited to these. It is to be noted that the sensor unit 65 is a tilt angle sensor, an accelerator, a gyro sensor, a global positioning system (GPS), or the like, but is not limited to this.

The power unit 66 supplies components of the terminal device 12 with power. The power unit 66 is an internal power source such as a battery, for example, but is not limited to this. The power unit 66 may detect a power amount constantly or at a predetermined time interval, and may monitor a remaining amount of power or the like.

For example, the radio unit 67 is a transmitter/receiver unit for communication data which receives a radio signal (communication data) from a base station through an antenna and transmits a radio signal to the base station through the antenna.

For example, the short-range communication unit 68 may perform near-range communication with a computer such as the other terminal device 12 and the like by using a communication method such as inferred communication, Wi-Fi (registered trademark), Bluetooth (registered trademark), or the like. The above-described radio unit 67 and the short-range communication unit 68 are communication interfaces, each allowing data transmission and reception with another computer.

The auxiliary storage device 69 is a storage device such as HDD or SSD, for example. The auxiliary storage device 69 stores various kinds of programs and performs input and output of data as appropriate.

The main storage device 70 stores the execution program and the like, which are read from the auxiliary storage device 69 by an instruction from the CPU 71 or stores various pieces of information obtained in executing the program. For example, the main storage device 70 is a ROM, RAM, or the like, but is not limited to this.

Based on the control program such as the OS or the execution program stored in the main storage device 70, the CPU 71 achieves various kinds of processing in the output control by controlling the operation of the entire computer such as an input and output of data with the various kinds of operations and the hardware components.

Specifically, for example, based on the program execution instruction obtained from the operation unit 64 or the like, the CPU 71 causes the program installed in the auxiliary storage device 69 to be executed, so that the processing corresponding to the program is performed on the main storage device 70. For example, the CPU 71 causes the display control device to be executed, so that the CPU 71 performs processing of causing the setting unit 35 to set the AR content or the determination conditions for determining whether the AR content is outputted, or the recognition unit 36 to recognize a reference object such as the AR marker. Also, the CPU 71 performs processing of causing the acquisition unit 37 to acquire the feature information (first feature information), the determination unit 38 to perform determinations, the content creation unit 39 to create the content, and the image creation unit 40 to create an image. The contents of the processing in the CPU 71 are not limited to these contents. The contents executed by the CPU 71 are stored in the auxiliary storage device 69 or the like as appropriate.

For example, a recording medium 73 may be detachably set in the drive device 72, and the drive device 72 may read various pieces of information recorded in the set recording medium 73 and write predetermined information in the recording medium 73. For example, the drive device 72 is a medium loading slot or the like, but is not limited to this.

The recording medium 73 is a computer readable recording medium which stores the execution program and the like. The recording medium 73 may be a semiconductor memory such as a flash memory, for example. Also, the recording medium 73 may be a movable recording medium such as a USB memory, but is not limited to this.

In the embodiment, the execution program (for example, the display control program or the like) is installed in the hardware configuration of the computer main unit, so that the display control processing or the like in the embodiment may be achieved with the cooperation of hardware resources and software.

In addition, the display control program corresponding to the display control program may be in a state of constantly existing on a device, for example, or may be activated by an activation instruction.

<Example AR Marker>

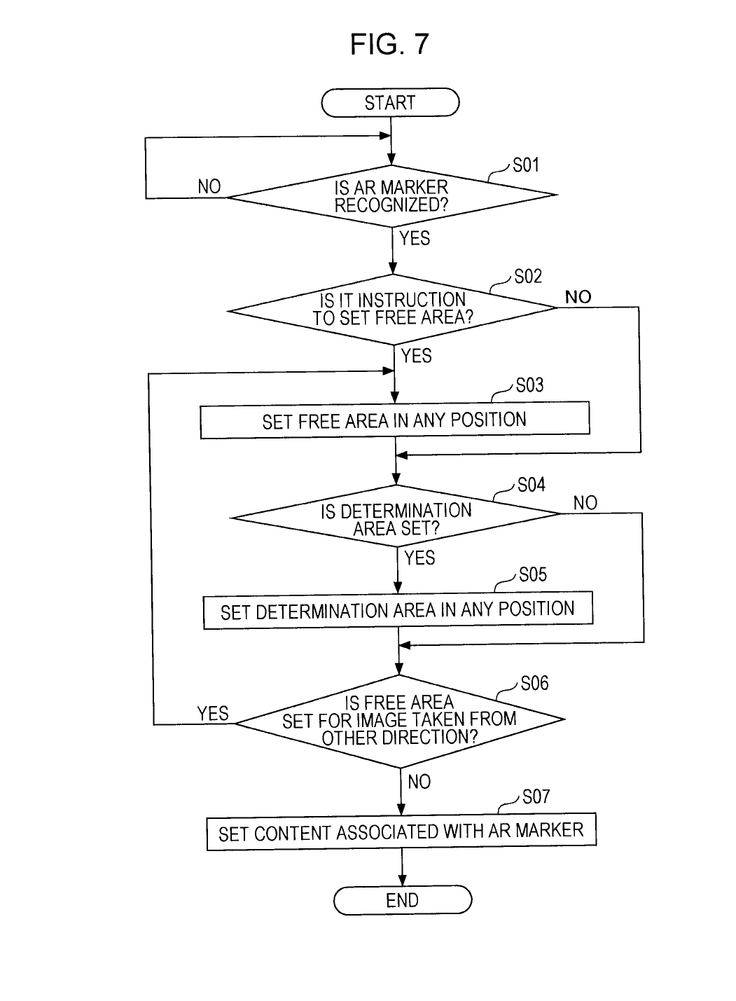

Hereinafter, an example AR marker in the embodiment is described by using the drawing. FIGS. 6A and 6B are diagrams illustrating an example in which an AR marker is provided in a real object. For example, an example in FIG. 6A, as an example of a real object (a target object) in reality space, a pipe (piping) 80 is provided. The pipe 80 has multiple valves 81-1 to 81-5. In the embodiment, an AR marker 90 is attached in a position which is capable of being captured with the pipe 80, for example.

In the embodiment, the AR marker 90 is captured by the image pickup unit 32 of the terminal device 12 together with the pipe 80, and the recognition unit 36 reads the identification information of the AR marker 90. Also, the acquisition unit 37 acquires the first feature information (for example, the free area, non-free area, and the like) which is associated with the identification information obtained by the recognition unit 36 and is defined by the coordinate value using the AR marker 90 as a reference. The determination unit 38 determines whether the feature information of the input image used by recognizing the identification information by the recognition unit 36 includes feature information based on the free area information or the non-free area information which is set in association with the identification information of the AR marker 90 recognized by the recognition unit 36. For example, the determination unit 38 determines whether the features of the corresponding image area, among the captured image captured by the image pickup unit 32, is consistent with (matches) the features indicated by the first feature information.

When the determination result obtained by the determination unit 38 is OK (when matches), it is determined that the image is captured from a proper position. The content creation unit 39 thus displays the AR content or the like which indicates how to use the valves 81-1 to 81-5 provided on the pipe 80 being a target object set in association with the identification information of the AR marker, for example, on an image being captured or a captured image in a superimposed manner, or registers new AR content. This allows the user (operator) to directly operate the valves 81-1 to 81-5 based on the AR content information displayed on the screen of the terminal device 12 to perform control and the like of the pipe 80. Also, multiple users may share the AR content information.

Also, the AR content information obtained from the AR marker 90 is not limited to the operation content. For example, in a case where the pipe 80 is damaged by a crack or the like or a case where it has to be repaired, the AR content information may be information to notify the user or the like of that information or notices.

One or more AR markers 90 may be provided in one target object (for example, the pipe 80), or one AR marker 90 may be provided in multiple target objects.

Also, as illustrated in FIG. 6B, as for a device (target device) such as a server rack 82 to accommodate a computer such as a server, the AR marker may acquire various pieces of information such as the operation content or the maintenance information (operating schedule, contact address in case of failure) by shooting an image of the AR marker 90 attached in the position where is capable of being captured together with the server rack and performing image recognition on that image.

For example, examples of the AR marker 90 may include two-dimensional code such as a barcode, QR code (registered trademark), or the like and multidimensional code using colors or the like, but are not limited to these. It is to be noted that the target object whose AR content is displayed according to the AR marker 90 is not limited to this.

<Example Processing in Terminal Device 12>

Hereinafter, example processing in the terminal device 12 is described by using a flowchart. It is to be noted that processing in the terminal device 12 includes, for example, a case where the user such as an administrator or an operator sets determination conditions (feature information) such as a free area in association with an AR marker and AR content and a case where the AR marker is recognized and associated AR content is displayed. It is to be noted that in the above case, one terminal device 12 may be used by the administrator or the operator or, for example, multiple terminal devices 12 is allocated to respective owners (an administrator and an operator) to perform processing. In the following description, example processing is separately described in each of the above cases.

<Example Processing of Setting Free Area and AR Content in First Embodiment>

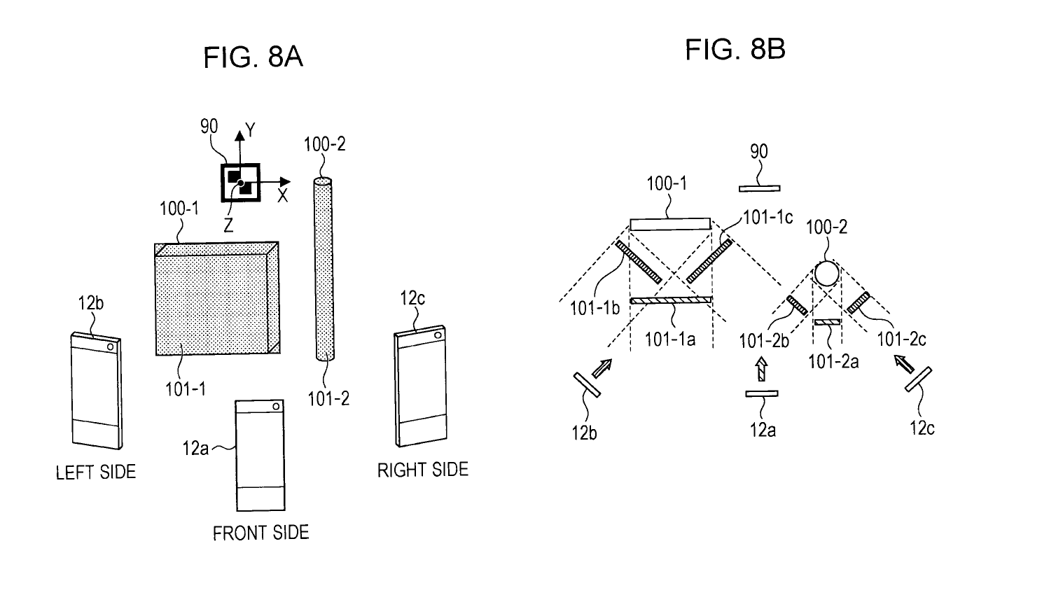

FIG. 7 is a flowchart illustrating example processing of setting a free area and AR content in the first embodiment. In the first embodiment illustrated in FIG. 7, the terminal device 12 determines whether an AR marker in an image captured by the user such as an administrator or an operator, for example is recognized (S01).

When the AR marker is not recognized (NO at S01), the terminal device 12 stands by until the AR marker is recognized. Also, when the AR marker is recognized in the captured image (YES at S01), the terminal device 12 determines whether it is an instruction to designate a free area (S02). When there is an instruction to set a free area at the operation of SO2 (YES at SO2), the setting unit 35 of the terminal device 12 accepts a range designation from the user and sets a free area in any position (S03). It is to be noted that in the operation of S03, for example, the user touches or drags an area on the screen, so that the free area and the like may be set.

Also, in the operation of S02, when a free area is not set (NO at S02), or after the operation of S03, the setting unit 35 determines whether a determination area is set (S04). When the determination area is set (YES at S04), the setting unit 35 sets a determination area in any position (S05). The determination area is an area in which an object for determination exists. For example, the object for determination is an object (for example, a target object, wall clock, PC, television, or the like) which is captured in the captured image together with the AR marker. For example, in the examples of FIGS. 6A and 6B, the pipe 80 or the server rack 82, which is a target object, is used as an object for determination, and an area on the image surrounding the object may be set as a determination area. In the example of FIG. 7, a determination object is also set as an example of the feature information (determination conditions).

In addition, in the operation of S04, when the determination area is not set (NO at S04), or after the operation of S05, it is determined whether a free area is set in an image captured from another direction with an instruction or the like of the user (S06). Here, when the free area is set in the image captured from another direction (YES at S06), the process returns to the operation of S03. Also, in the operation of S06, when the free area is not set in the image captured from another direction (NO at S06), the AR content associated with the AR marker recognized at S01 is set (S07).

It is to be noted that the above processing is an example of setting the free area, but is not limited to this, and a non-free area may be set. For example, an area other than the free area set in the captured image may be a non-free area. When the non-free area is set in the image, an area other than the non-free area in the image becomes a free area.

<Specific Example of Setting Free Area in First Embodiment>

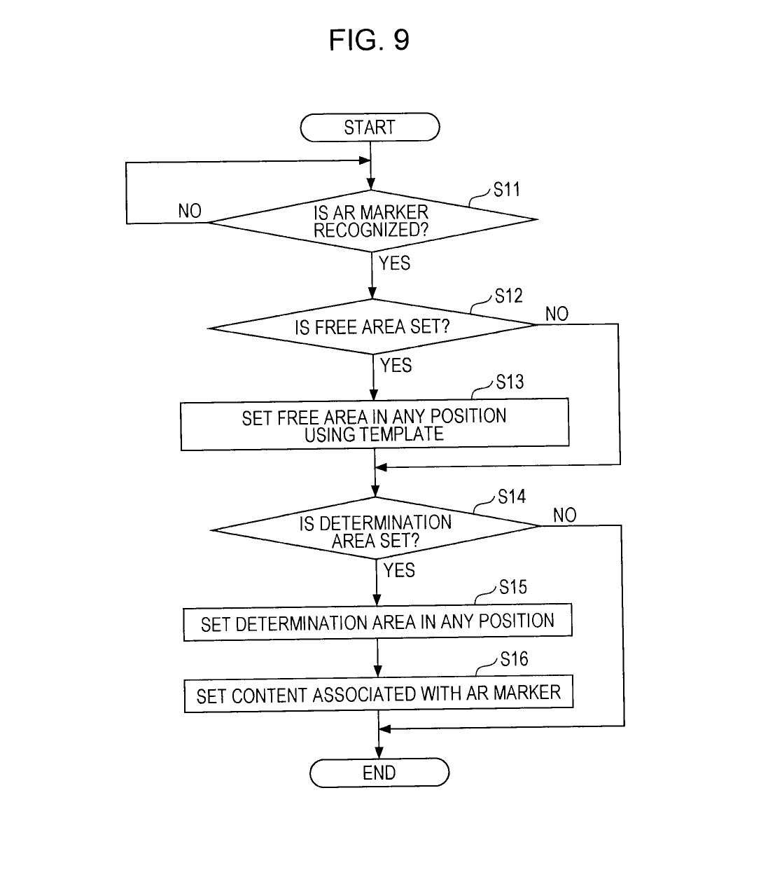

FIGS. 8A and 8B are diagrams illustrating a specific example of setting a free area in the first embodiment. The example of FIG. 8A is a diagram illustrating a shooting direction in the terminal device 12. The example of FIG. 8B illustrates a bird's eye view of a setting state corresponding to FIG. 8A.

In the example of FIG. 8A, when the AR content is set using the display control program or the like (for example, the authoring function) in the embodiment, an area (non-free area) in which the AR content is not displayed is set. It is to be noted that in the first embodiment, the example is not limited to the above example, and an area (free area) in which AR content is displayed may be set.

In the example of FIG. 8A, two real objects 100-1 and 100-2 exist in the reality space. The real object 100-1, 100-2 is the pipe or the server rack 82, for example. When the AR content corresponding to the real object 100-1, 100-2 is set in association with AR marker 90, the user sets a non-free area 101-1, 101-2 so as not to hide the real object 100-1, 100-2 with the superimposed AR content. In the example of FIG. 8A, the non-free area 101-1, 101-2 is set so as to cover the real object 100-1, 100-2.

Also, in the embodiment, setting is possible not only from some one direction (for example, a front direction with respect to the AR marker 90) but also from other directions (for example, right side direction and left side direction). Accordingly, for example, when the non-free areas coincidentally match with each other in the one direction, an unwilling determination result may be avoided. It is to be noted that the marker identification information or the setting information of the AR content in the state where the non-free area is set are transmitted to the server 11 and managed thereby.

Also, when he AR content registered in the server 11 is acquired by shooting the AR marker, for example, it is determined whether the AR marker 90 and the non-free area from multiple positions match each other at the time of determination. In this manner, the non-free area is set from the multiple positions, so that the non-free region may be three-dimensionally set. In the example of FIG. 8B, non-free areas 101-1a, 101-2a are set for the real objects 100-1, 100-2 from a terminal device 12a in the front direction of the marker 90. Also, non-free areas 101-1b, 101-2b are set for the real objects 100-1, 100-2 from a terminal device 12b in the left side direction of the AR marker 90. Moreover, non-free areas 101-1c, 101-2c are set for the real objects 100-1, 100-2 from a terminal device 12c in the right side direction of the AR marker 90. The AR marker and the areas (position information) such as the free areas, which are obtained from the settings are managed by a marker coordinate system (X, Y, Z) using the center position of the marker as a reference, for example, but they are not limited to this. For example, they may be managed by a screen coordinate system using a position where a captured image exists as a reference.

<Example Processing of Setting Free Area and AR Content in Second Embodiment>

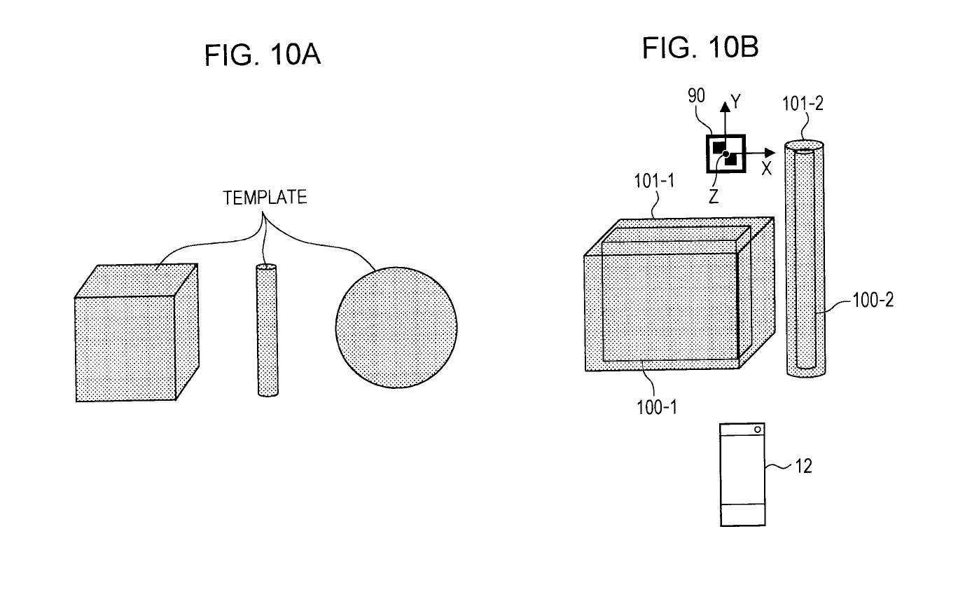

FIG. 9 is a flowchart illustrating an example processing of setting a free area and AR content in a second embodiment. In the second embodiment illustrated in FIG. 9, a terminal device 12 determines whether an AR marker in an image captured by the user such as an administrator or an operator is recognized (S11). When the AR marker is not recognized (NO at S11), the terminal device 12 stands by until the AR marker is recognized.

When the AR marker is recognized (YES at S11), it is determined whether an instruction to set a free area has been accepted (S12). When there is the instruction to set the free area from the user or the like in the operation of S12 (YES at S12), a setting unit 35 of the terminal device 12 sets the free area in any position using a template or the like of the non-free area which is stored in a storage unit 33 in advance (S13).

When the free area is not set in the operation of S12 (NO at S12), or after the operation of S13, the setting unit 35 determines whether a determination area is set (S14). When the determination area is set (YES at S14), the determination area is set in any position (S15). Next, the setting unit 35 sets content associated with a marker (S16).

Here, when the free area is not set in the operation of S12 (NO at S12) or when the determination area is not set in the operation of S14 (NO at S14), or after the operation of S16, the processing is terminated.

It is to be noted that in the second embodiment, as similar to the first embodiment, settings may be performed on an image captured from another direction.

<Specific Example of Setting Free Area in Second Embodiment>

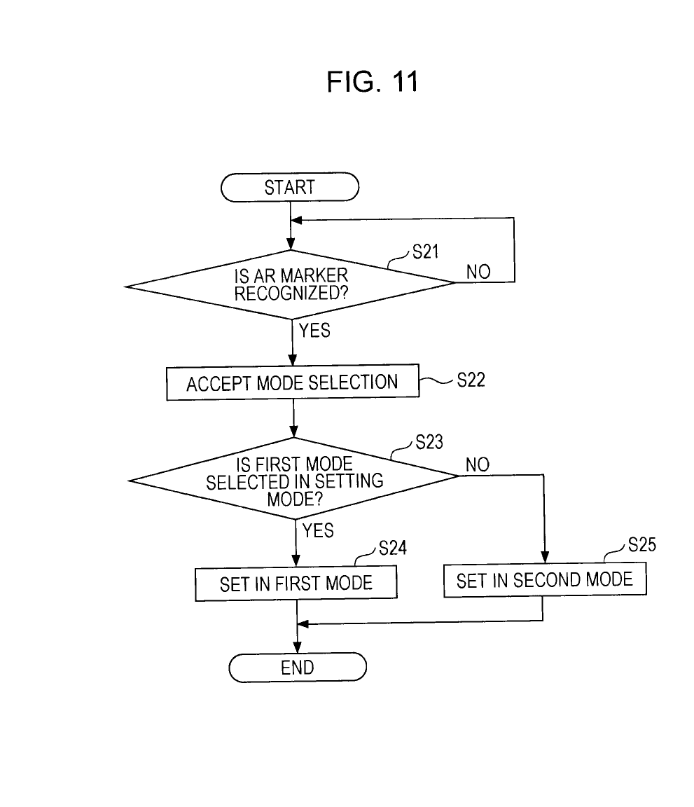

FIGS. 10A and 10B are diagrams illustrating a specific example of setting a free area in the second embodiment. FIG. 10A is a diagram illustrating an image shooting direction in the terminal device 12. FIG. 10B illustrates an example setting state.

In the second embodiment, an AR marker, a non-free area, and a determination area are set and AR content associated with the AR marker is also set. It is to be noted that in the example of FIG. 10A, a template of an area in which the AR content is not displayed (non-free area) is illustrated, but an area where the AR content is displayed (free area) may be set.

In the setting processing in the second embodiment, one or multiple templates in which a non-free area is set in advance (in the example of FIG. 10A, three) may be used to perform setting. In the example of FIG. 10A, the templates respectively illustrate “cubic”, “cylinder”, and “sphere”. However, they are not limited to these types and number and may be an initial image (plane) or the like, such as a squire or a circular, for example.

Also, in the second embodiment, an arbitrary position in relation to the AR marker 90 may be set as a non-free area in such a manner that one template selected from the templates and the like is displayed on a screen, and the displayed template is enlarged to any size or is changed in shape with an operation (for example, pinch in, pinch out, flick) on a screen (touch panel) of the terminal device 12 (FIG. 10B).

In the example of FIG. 10B, the non-free areas 101-1, 101-2 using the templates are selected along with the shapes of the real objects 100-1, 100-2. The non-free area 101 set in the second embodiment may be set to be larger or smaller than the real object on the screen in correspondence to the security strength, for example. For example, when the non-free area is set so as to be wider than the real object, the number of feature points used for object recognition may be increased, so that the security strength becomes high. When it is set so as to be smaller than the real object, the number of feature points may be reduced, which results in reducing the security strength. Since a range of the object recognition is affected by the size of the non-free area, the setting unit 35 may perform adjustment on the security strength. Also, the object used as the non-free area may not be all the real objects included in the captured image but may be at least one selected object. The AR marker and the area (position information) such as the free area, which are obtained from the settings, are managed with a marker coordinate system (X, Y, Z) using the center position of the marker as a reference, for example. However, they are not limited to this and may be managed with a screen coordinate system.

<Example Processing of Setting Free Area in Third Embodiment>

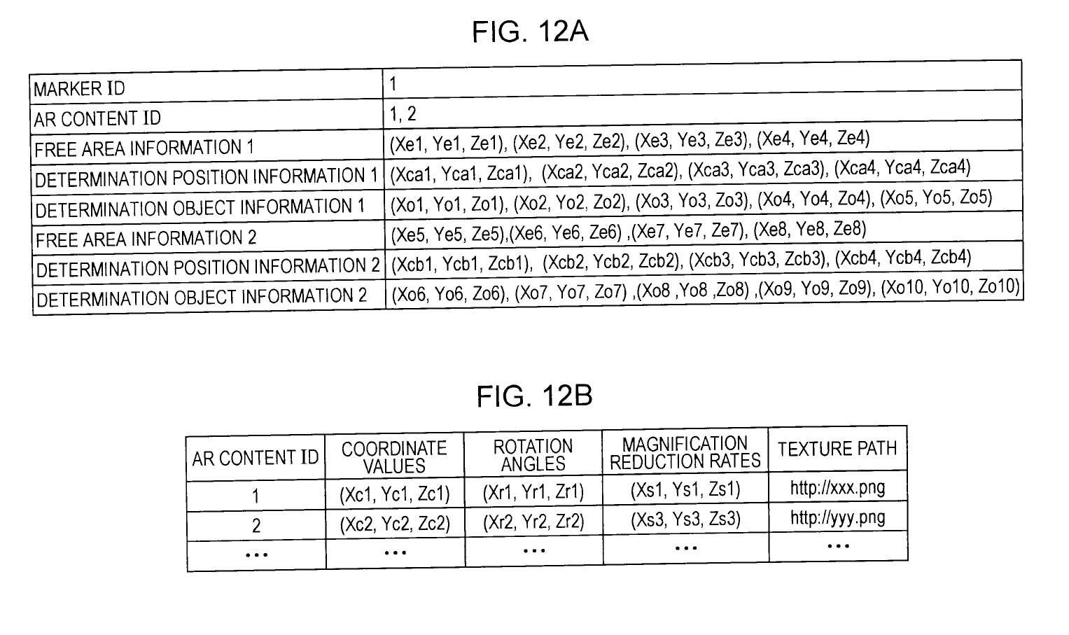

FIG. 11 is a flowchart illustrating example processing of setting a free area in a third embodiment. The third embodiment illustrated in FIG. 11 is designed so that an administrator or the like may select one of the setting method in the first embodiment as a first mode and the setting mode in the second embodiment as a second mode with a mode selection.

In the example of FIG. 11, the terminal device 12 determines whether an AR marker in an image captured by the user such as an administrator or an operator is recognized (S21). When an AR marker is not recognized (NO at S21), the terminal device 12 stands by until an AR marker is recognized.

Also, when an AR marker is recognized in the captured image (YES at S21), a mode selection performed by the administrator or the like is accepted through a screen or the like which is set in advance (S22). Then, the setting unit 35 determines from the operation of S22 whether the first mode is selected with the setting mode (S23). When the first mode is selected (YES at S23), the setting in the first mode (first embodiment) is performed (S24). Also, when the first mode is not selected with the setting mode at the operation of S23 (NO at S23), the setting in the second mode (second embodiment) is performed (S25). It is to be noted that the mode is not limited to this, and when there are three or more modes, a mode corresponding to each of the mode selection results is executed.

<Example Data>

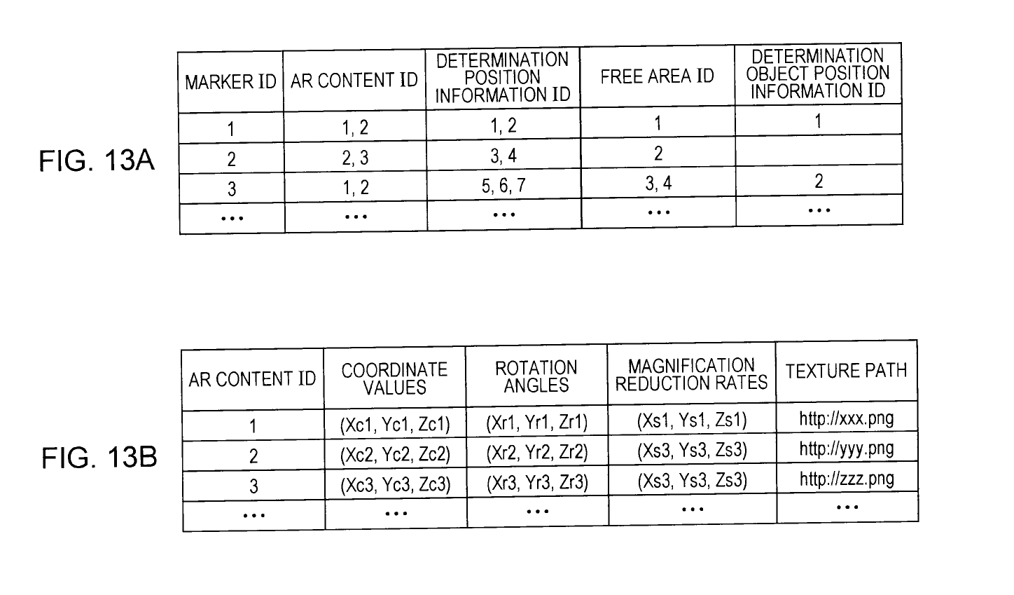

The description is given of example data in the embodiments by using the drawing. It is to be noted that in the following example data, a three-dimensional coordinate system is used as an example coordinate system indicating position information or the like, but the example data is not limited to this. For example, it may be a two-dimensional coordinate system (X, Y). FIGS. 12A and 12B are diagrams illustrating data example included in the terminal device. FIG. 12A illustrates an example data management table. FIG. 12B illustrates an example AR content management table.

As items of the data management table illustrated in FIG. 12A include, for example, “marker ID”, “AR content ID”, “free area information”, “determination position information”, “determination object information”, and the like, but are not limited to these.

The “marker ID” is information to identify an AR marker. The “AR content ID” is information to identify AR content set in association with a marker ID. One or multiple AR content IDs may be set for one marker ID. Also, the content ID corresponding to the marker ID may be changed as appropriate. The “free area information” is coordinates of the free area on the three-dimensional space (virtual space) of a captured image. It is to be noted that information on a non-free area may be stored in the “free area information”. In that case, a flag or the like indicating the area is also stored. The “determination position information” is coordinates of the position information of the AR marker to be determined. The “determination object information” is determination object information that is for example, a coordinate value of feature points of an object for determination in a determination position of the free area, but is not limited to this.

As items of the AR content management table illustrated in FIG. 12B include, for example, “AR content ID”, “coordinate value”, “rotation angle”, “magnification reduction rate”, “texture path”, and the like, but are not limited to these. For example, when the setting is performed using a template with a shape as illustrated in the second embodiment, identification information of the template may be included.

The “AR content ID” is identification information to identify AR content and is associated with the AR content ID in the data management table illustrated in FIG. 12A. The “coordinate value” is coordinates to display the AR content on the three-dimensional space (virtual space) of the captured image. In the example of FIG. 12B, the coordinate value in the center of the AR content is set, but is not limited to this. The “rotation angle” is information to indicate how much rotated in the three-dimensional space from a reference angle using a predetermined position such as the front, for example, set in advance. The “magnification reduction rate” is information to indicate a magnification and reduction rate with respect to the size which is a reference. The “texture path” is information to indicate a storage destination address of an image file or the like, which is set in the AR content, for example. It is to be noted that an access may be made to the storage destination of the AR content through the above-described communication network 13, for example, but it is not limited to this. The storage destination is, for example, the server 11, but is not limited to this. For example, the storage destination may be an image file or the like to be disclosed on the web.

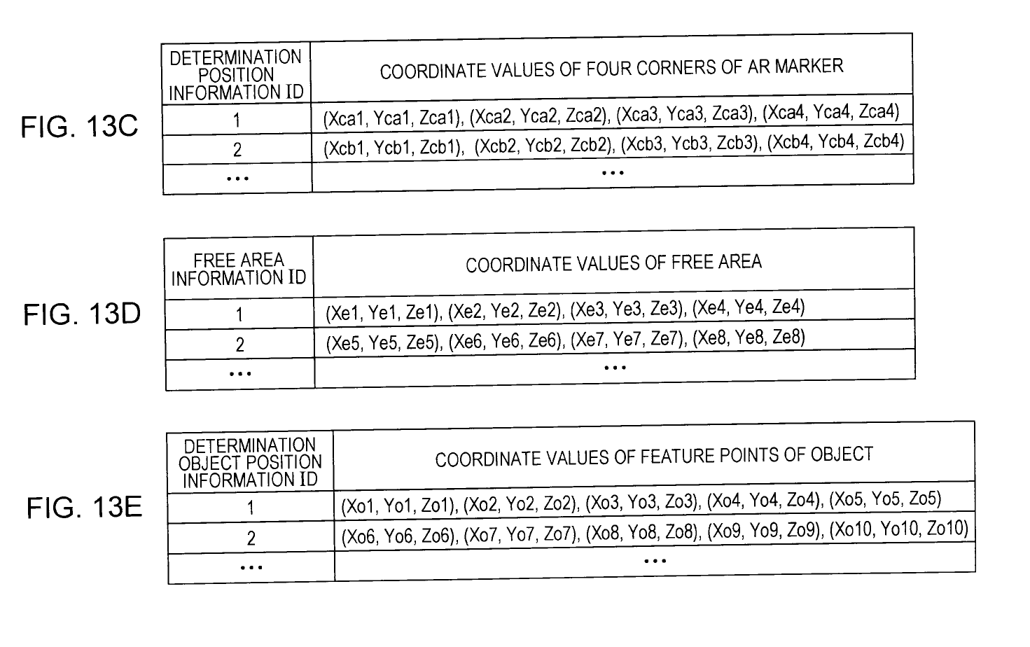

FIGS. 13A to 13E are diagrams illustrating example data included in the server. FIG. 13A illustrates an example marker ID management table. FIG. 13B illustrates an example AR content management table. FIG. 13C illustrates an example determination position information management table. FIG. 13D illustrates an example free area information management table. FIG. 13E illustrates an example determination object position information management table.

As items of the marker ID management table illustrated in FIG. 13A include, for example, “marker ID”, “AR content ID”, “determination position information ID”, “determination object position information ID”, and the like, but are not limited to these. The marker ID management table illustrated in FIG. 13A stores feature information (“determination position information ID”, “free area ID”, “determination object position information ID”) corresponding to one or more pieces of the AR content associated with the marker ID and the determination conditions to display the AR content. These pieces of the feature information have to include at least one of the position information of the AR marker, the free area, and the position information of the determination object. However, the feature information is not limited to this.

As items of the AR content management table illustrated in FIG. 13B include, for example, as illustrated in FIG. 12B “AR content ID”, “coordinate value”, “rotation angle”, “magnification reduction rate”, “texture path”, and the like, but are not limited to these. For example, when the setting is performed using a template with a shape as illustrated in the second embodiment, identification information of the template may be included.

As items of the free area information management table illustrated in FIG. 13C include, for example, “free area information ID”, “coordinate value of free area”, and the like, but are not limited to these. The position information for each of the free areas may be acquired by the free area information management table.

As items of the determination position information management table illustrated in FIG. 13D include, for example, “determination position information ID”, “coordinate value of the AR marker in four corners”, and the like, but are not limited to these. The position information of the AR marker may be acquired by the determination position information management table.

As items of the determination object position information management table illustrated in FIG. 13E include, for example, “determination object position information ID”, “coordinate value of feature points of an object”, and the like, but are not limited to these. The position information of the determination object may be acquired by the determination object position information management table.

It is to be noted that the example data included in the server 11 illustrated in FIGS. 13A to 13E is information obtained from one or more terminal devices 12. Accordingly, each piece of the data may be managed together with identification information (terminal ID) to identify the terminal device 12, for example.

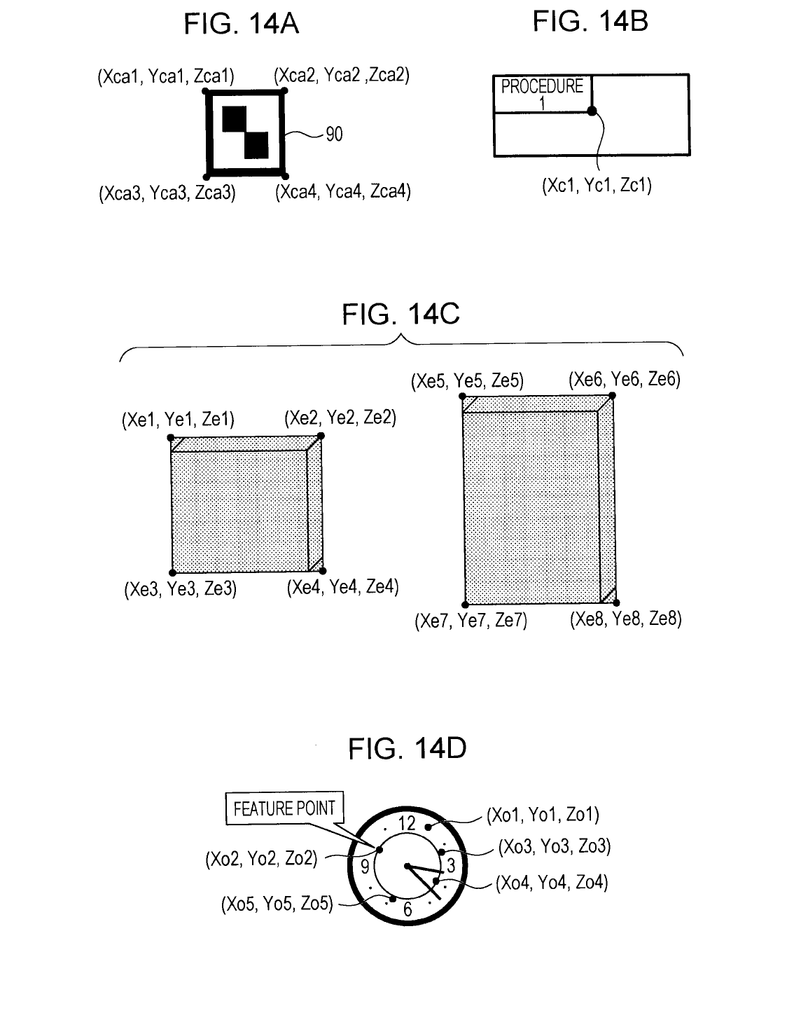

Here, FIGS. 14A to 14D are diagrams illustrating coordinate values set in each table. FIG. 14A illustrates a coordinate value of the AR marker. FIG. 14B is a coordinate value of the AR content. FIG. 14C illustrates a coordinate value of the non-free area. FIG. 14D illustrates an example feature point of an object in the recognition object position information management table.

In FIG. 14A, the coordinate value in four corners on the three-dimensional space, which positions the AR marker 90, is managed by the table. It is to be noted that the coordinate value of the AR marker 90 is not limited to this, but, for example, may be center coordinates of the AR marker 90.

In FIG. 14B, the center coordinate value on the three-dimensional space, which positions the AR content, is managed by the table. It is to be noted that in the example of FIG. 14B, as an example of the AR content, a procedure to operate a target object associated with the AR marker 90 is illustrated, but the AR content is not limited to this.

In the example of FIG. 14C, a coordinate value of multiple non-free areas in the three-dimensional space in four corners is set for each of the areas. In the example of FIG. 14C, the coordinate value of two non-free areas in four corners is managed by the table in association with the two real objects.

In the example of FIG. 14D, when a real object existing in a captured image is used for determination, feature points of the object in the three-dimensional space are set in advance and a coordinate value of the feature points is set in the table. Accordingly, when it is determined that the AR marker is captured in a proper position, the information (coordinate value of the feature point) of this object may be used as one of the determination conditions.

It is to be noted that each of the coordinate values may be a marker coordinate system or a screen coordinate system, or may be a combination thereof or be a value converted to a predetermined coordinate system with coordinate conversion or the like.

<Example Display Control Processing>

Described hereinafter by using a flowchart is example display control processing performed when the AR content associated with the AR marker which is actually captured by an operator or the like is displayed based on the determination conditions set by an administrator, for example.

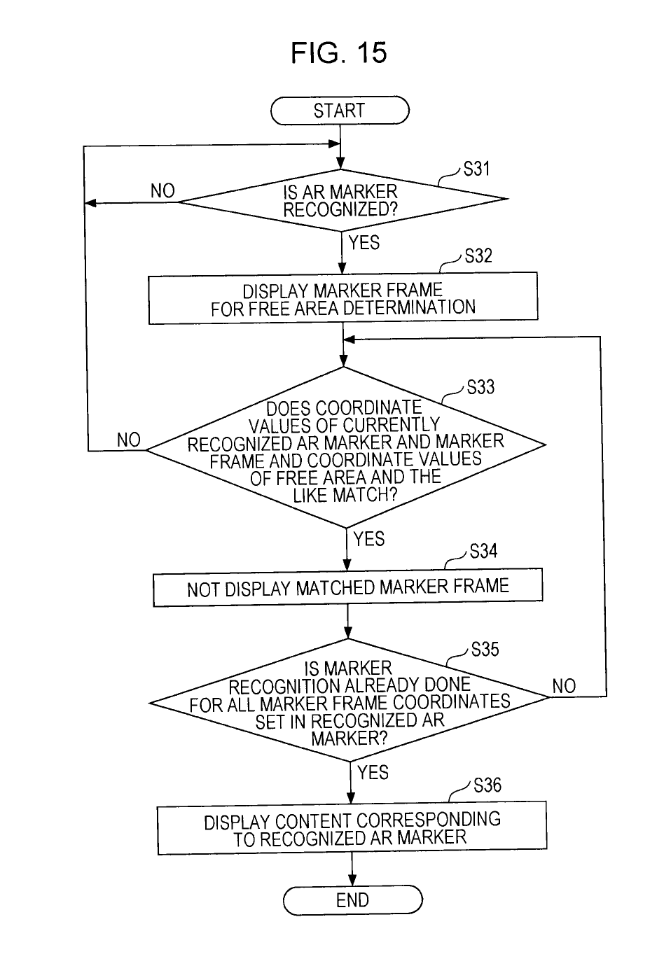

FIG. 15 is a flowchart illustrating example display control processing. In the example of FIG. 15, it is determined whether an AR marker existing in an image captured by the image pickup unit 32 of the terminal 12 by the user such as an operator is recognized (S31). When an AR marker is not recognized (NO at S31), the recognition unit 36 of the terminal device 12 returns to the operation of S31 and stands by until an AR marker is recognized. It is to be noted that when an AR marker is not recognized for more than a predetermined period of time, the processing may be terminated.

At the operation of S31, when an AR marker existing in the image is recognized (YES at S31), the recognition unit 36 display a marker frame for free area determination (S32). This marker frame is displayed on a screen, so that user navigation becomes possible to perform matching determination (determination of match or not match) using the free area (non-free area), feature information on a determination object or the like, and the like based on the image captured in a state where the AR marker is within the frame. In addition, the marker frame may be acquired from the determination position information management table and the like illustrated in FIG. 13D. When it is determined that images of a marker are captured from multiple directions and are captured in a proper position (on-site), multiple marker frames are displayed.

Next, the determination unit 38 matches the feature information acquired for the currently recognized AR marker with the preset feature information. For example, the determination unit 38 determines whether the currently recognized AR marker and the coordinate values of the marker frame and the free area or the like match each other (S33). It is to be noted that in the operation of S33, for example, the coordinate value of the preset AR marker or the free area (or non-free area) is used in the processing of setting the free area (or non-free area) or the AR content. Also, the information of the free area or the like for the currently recognized AR marker may be acquired by using the determination object position or feature point extraction, brightness difference information, and the like with respect to the captured image. However, it is not limited to this.

Also, in the operation of S33, it is likely difficult that the coordinate values match completely. Accordingly, an allowable range is set in advance, and when the coordinate values are included in that allowable range (in the case where the coordinate values are alike for some extent), it may be determined that the values match each other. Also, in the operation of S33, the determination on whether the values match each other may be performed not only by the coordinate value of the free area but also the coordinate value of the feature information of the determination object (real object) existing in the captured image. In addition, the determination on whether the values match each other may be performed by using the free area and the determination object.

At the operation of S33, when the coordinate values of the currently recognized marker and the marker frame and the coordinate value of the free area or the like do not match each other (NO at S33), the determination unit 38 returns to the operation of S31. At this time, an error message may be displayed on a screen. Also, when the coordinate values of the currently recognized marker and the marker frame and the coordinate value of the free area or the like match each other (YES at S33), the determination unit 38 determines that the marker is captured from a proper position. Accordingly, the matched marker frame is not displayed (S34).

Next, the determination unit 38 determines whether a marker has been already recognized in all marker frame coordinates set in the recognized marker (S35). When it has not been recognized yet (NO at S35), the determination unit 38 returns to the operation of S33 to perform matching determination by comparing another marker frame with the coordinate value. Also, when a marker has been already recognized in all marker frame coordinates (YES at S35), the determination unit 38 acquires the AR content corresponding to the AR marker from the server 11 or the like based on the identification information (marker ID) of the recognized AR marker and displays it in a predetermined position on the screen (S36). It is to be noted that in the operation of S36, processing of setting new piece of AR content may be performed. With this setting, the AR content may be displayed in a proper position in association with the AR marker captured in a proper shooting position or may be registered.

Here, in the display control processing, the comparison of the coordinate values in the operation of S33 is performed on the terminal device 12 side. However, the embodiment is not limited to this, but it may be performed on the server 11 side. In this case, the feature information (coordinate value and the like) related with the identification information (marker ID) of the recognized AR marker are transmitted to the server 11, and when the extraction unit 24 of the server 11 extracts the AR content associated with the marker ID from the storage unit 22, the determination may be performed based on the coordinate value.

<Navigation Example of Shooting Position>

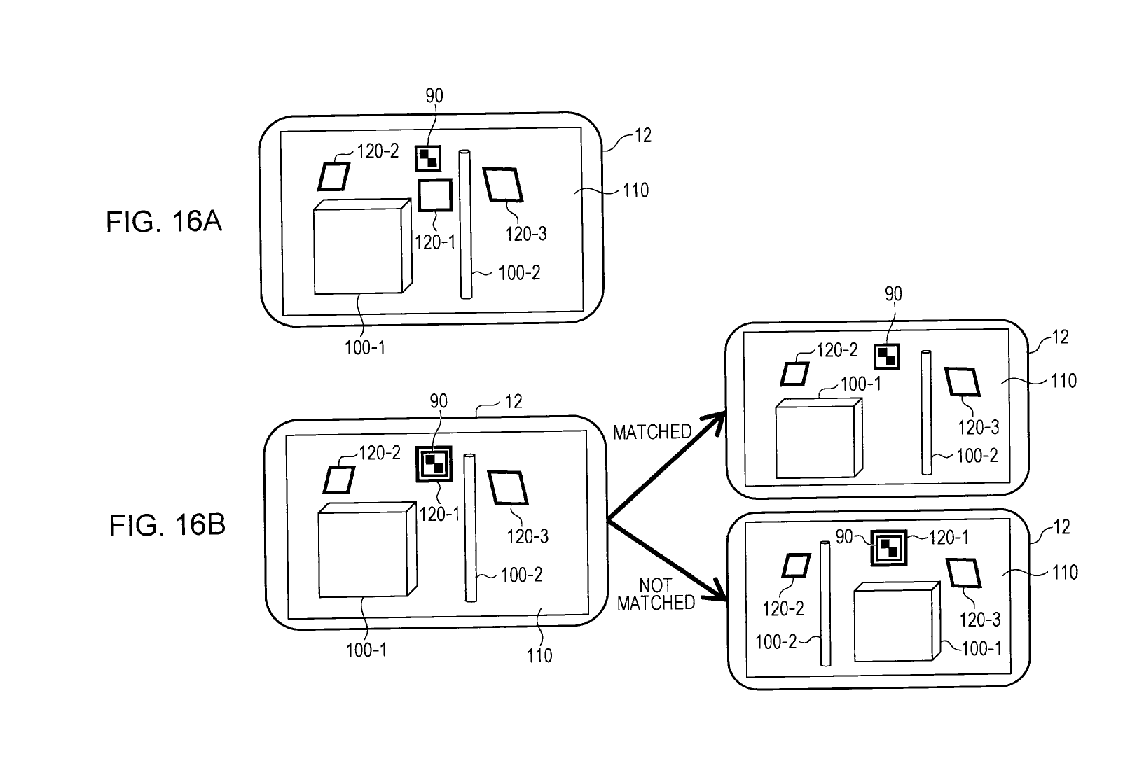

Described hereinafter is an example shooting position navigation using the marker frame. FIGS. 16A and 16B are diagrams illustrating a navigation example of a shooting position. FIG. 16A illustrates an example display of the marker frame. FIG. 16B illustrates an example operation after the matching determination result using the feature information with respect to the image captured within the marker frame.

In FIG. 16A, a screen 110 of the terminal device 12 has the real objects 100-1, 100-2 and the AR marker 90 to display content such as operation procedures or notices associated with the real objects 100-1, 100-2.

For example, when the display control in the embodiment is performed, as illustrated in FIG. 16A, a marker frame (marker outline frame) 120 in the marker recognition position when determination is performed is displayed on the screen. A position where an area of the marker frame 120 matches with the shape (coordinate value) in the image of the actually recognized AR marker becomes a position where a free area (non-free area) is set in advance. Accordingly, the image captured by that position is used to perform determination processing using the free area (non-free area) or determination object.

When the feature information using, for example, the free area and the object positions in the image match as a result of the determination, as illustrated in FIG. 16B, the marker frame 120-1 disappears from the screen 110. Also, the user is notified of instruction information to be displayed on the screen or outputted by voice to instruct that determination is also performed on other marker frames 120-2, 120-3. Then, when feature information match in all the marker frames, the already registered AR content is displayed on the screen 110.

In addition, in FIG. 16B, when the determination results using, for example, the non-free area or the like do not match, the area of the marker frame 120-1 remains. In this case, the terminal device 12 displays information or an error message that causes the user to recognize the AR marker again on the screen 110. In this manner, in the embodiment, the marker frame is displayed, so as to be capable of performing control to lead the feature information such as the free area or the like into an angular field.

It is to be noted that in the examples of FIGS. 16A and 16B, the three marker frames 120-1 to 120-3 are illustrated and a navigation is made so that an image be taken from each of the angles. However, the shooting position is not limited to this. Also, the marker frame 120 does not have to match with the outer frame of the AR marker 90 and only has to be included in an allowable range set in advance.

Also, in the embodiment, for example, control may be performed in such a manner that the order of the marker frames 120 into which the AR marker 90 is included and the like are set in advance, and not-matching determination is made when it is unable to be included in the marker frame in the predetermined order.

<Example Determination Using Determination Object>

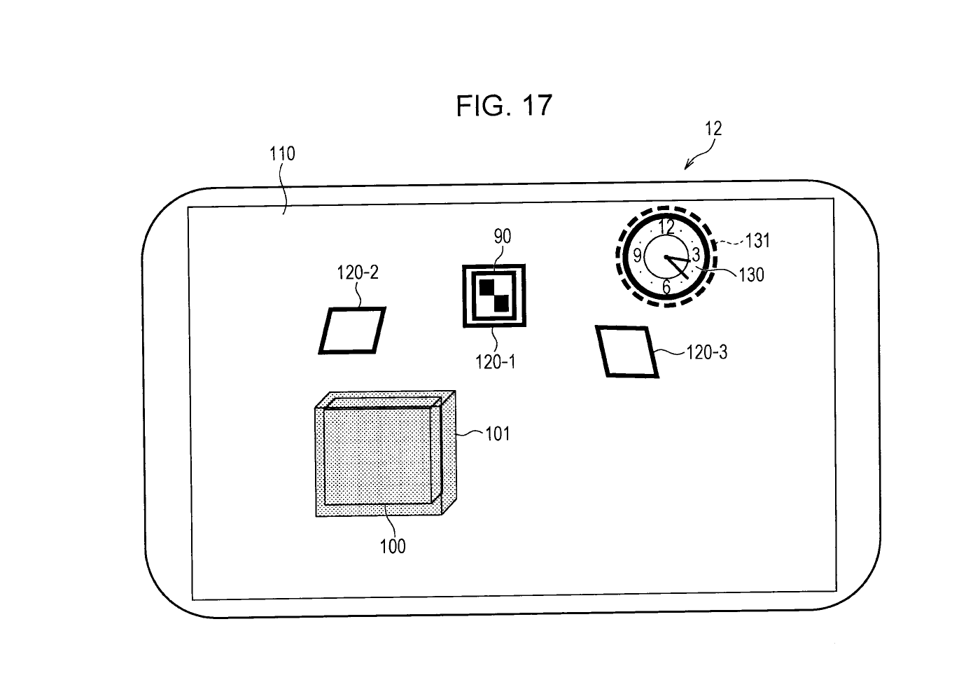

Hereafter, an example determination using a determination object is described by using the drawing. FIG. 17 is a diagram illustrating an example determination using a determination object. In the example of FIG. 17, a real object (such as a clock) included in a captured image obtained by the image pickup unit 32 of the terminal device 12 is used as a determination object 130 for determination.

For example, when a percentage of the non-free area is small in the entire captured image, accuracy in the determination on whether the image is captured in that place may be deteriorated by using the non-free area. This relates to that object recognition accuracy is deteriorated because an object in the captured image is small. For this reason, in the embodiment, another object (in the example of FIG. 17, it is a clock) captured in an area other than the non-free area included in the captured image is set as a determination object 130, and determination is performed by using feature information (coordinate value) 131 in the range of the determination object. Accordingly, the determination accuracy may be improved.

In the example of FIG. 17, in the captured image displayed on the screen 110 of the terminal device 12, when a percentage of the non-free area 101 in the entire image (for example, an area rate of the screen), a specific object (determination object 130) is set in a relative position from the AR marker 90. Also, the feature information 131 of the set determination object 130 is used, so that the determination accuracy is capable of being improved. Also, in the embodiment, the determination object 130 is set in a relative position from the AR marker 90, so that the accuracy and processing time desired for object recognition is capable of being improved.

<Example Display Screen in Terminal Device 12>

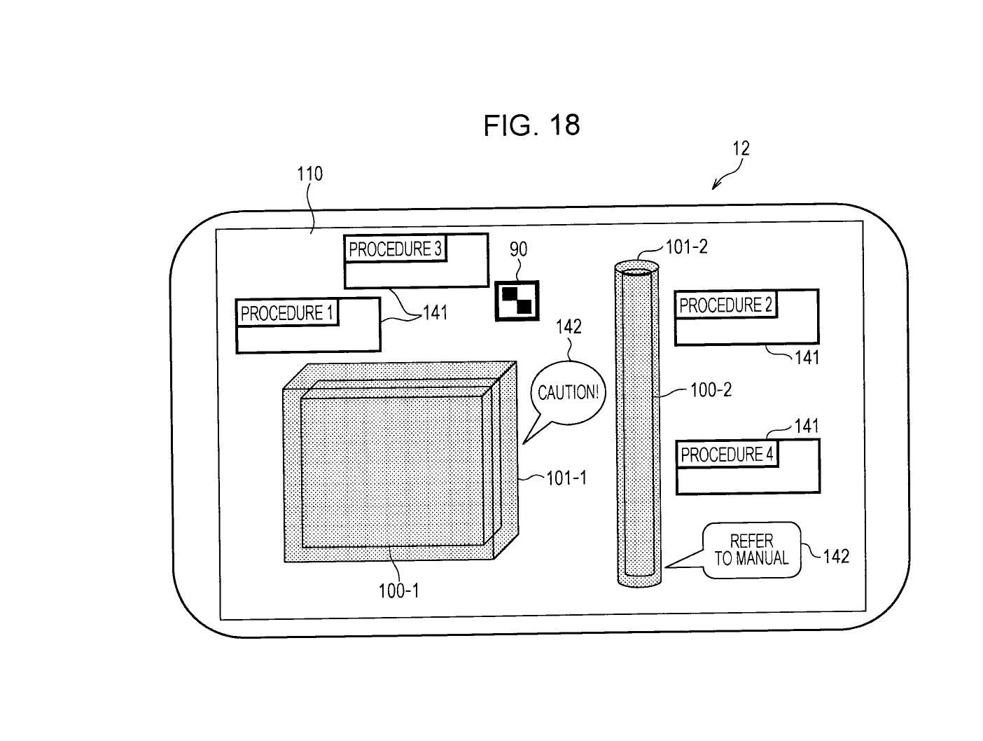

Hereinafter, a display screen example in the terminal device 12 is described by using the drawing. FIG. 18 is a diagram illustrating an example display screen of the terminal device. In the example of FIG. 18, the terminal device 12 has the real objects 100-1, 100-2 and the AR marker 90 corresponding to thereto on the screen 110. In the example of FIG. 18, the non-free areas 101-1, 101-2 are respectively set to the real objects 100-1, 100-2 on the screen 110. It is to be noted that the non-free areas 101-1, 101-2 are not displayed at the time of determination. The pieces of AR content 141, 142 illustrated in FIG. 18 are displayed in a place which is not overlapped with the non-free area 101.

In the embodiment, as illustrated in FIG. 18, for example, as the AR content associated with the AR marker 90, the AR content 141 indicating operation procedures for the real objects 100-1, 100-2, and the AR content 142 such as notices or comments are displayed on the screen 110. These pieces of the AR content may be set in association with the AR marker by one or multiple users (an administrator and an operator), and are displayed in a position on the preset three-dimensional space. Accordingly, the information may be provided and shared among the multiple users. It is to be noted that the AR content is displayed on the free area set in advance based on the marker coordinate system, for example.

Also, the contents of the AR content are not limited to the example illustrated in FIG. 18. For example, the AR content illustrated in FIG. 18 is selected (touched) from the screen 110, so that the content such as movie, voice, or detailed information corresponding to the AR content information may be outputted. The AR content is displayed on the free area set in advance.

<Example Display of AR Content>

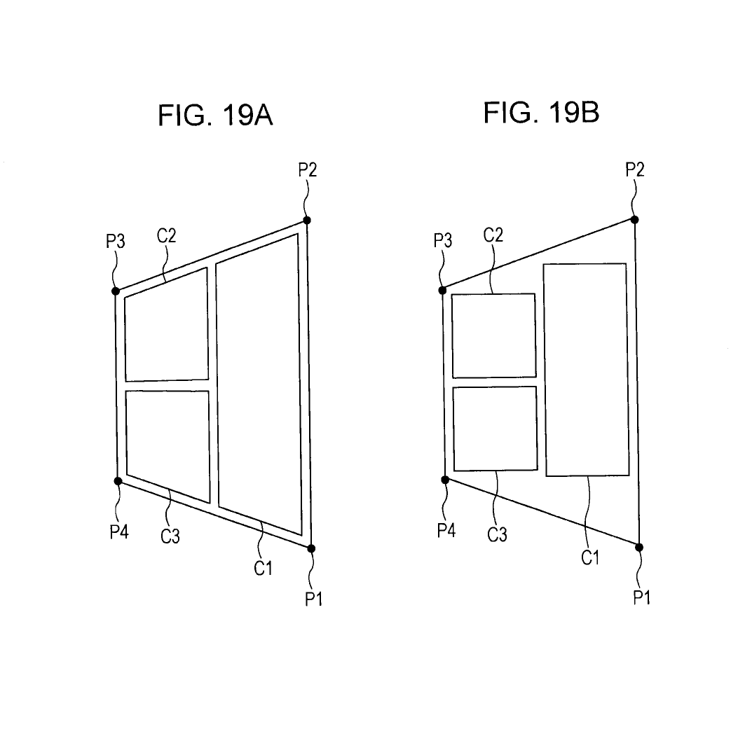

FIGS. 19A and 19B is diagram illustrating an example display of content with respect to the free area. For example, the AR content associated with the AR marker is displayed on the free area in set in advance. This free area is set in the front direction of the AR marker, for example. Here, when the image is captured by going behind the right side of the AR marker, the squire formed by the coordinates P1 to P4 of the free area in four corners becomes a distorted square.

For this reason, as an example display of the AR content, as illustrated in FIG. 19A, for example, each pieces of the content C1 to C3 is mapped in the area of the distorted squire of the free area with the marker coordinate system, and projected images of the mapped content C1 to C3 are respectively created. Thus, as illustrated in FIG. 19A, the AR content C1 to C3 are displayed as an image attached to a wall.

Also, as another example, as illustrated in FIG. 19B, the pieces of the AR content C1 to C3 are respectively mapped within the squire free area. Displaying the content as illustrated in FIG. 19B, each piece of the content faces the front to the screen. Accordingly, the displayed information becomes easy to be seen.

Here, the free area or the like in the embodiment may be edited as the AR content, for example, or may be created based on the features or the like of the image. Also, in the embodiment, when determination on whether the free area is included is performed in the terminal device 12, such a state is possible that the terminal device 12 is not connected with the server 11 (off-line environment). In this case, for example, the AR content corresponding to the marker ID is held in the terminal device 12 in advance, and the terminal device 12 performs determination corresponding to the marker ID without the server 11, and then the AR content held in the terminal device 12 may be displayed according to the determination result. Also, in the embodiment, it may be designed so that referring the AR content is suppressed when the user is registering the AR content relating to the AR marker. Also, in the embodiment, a shooting position may be determined in combination with the position information obtained from GPS or the like of the terminal device 12.

As described above, the embodiment may achieve proper display control. For example, the embodiment may control display content which is performed according to recognition of an AR marker based on the placement of the AR marker.

The embodiments are described in detail above but are not limited to a particular embodiment, and the various modifications and changes are possible without departing from the scope of claims. Also, one or all portions of the embodiments may be combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A terminal device, comprising:
a memory; and
a processor coupled to the memory, wherein
the processor is configured to
recognize a reference object included in an input image,
determine whether feature information of the input image used for recognizing the reference object includes feature information based on free area information or non-free area information set in association with identification information of the recognized reference object, and
create an image in which content associated with the identification information is superimposed on the input image based on a result of the determination.

2. The terminal device according to claim 1, wherein the processor uses input image used for recognizing the reference object captured from multiple directions to determine whether the feature information of the input image includes feature information based on the free area information or the non-free area information.

3. The terminal device according to claim 1, wherein the processor determines whether the feature information of the input image used for recognizing the reference object includes feature information of a determination object set in association with identification information of the recognized reference object.

4. The terminal device according to claim 1, wherein the processor sets the feature information based on the free area information or the non-free area information and the content in association with position information of the reference object with respect to the input image used for recognizing the reference object.

5. The terminal device according to claim 1, wherein the free area information or the non-free area information is area information defined by relative coordinates from the reference object.

6. A display control method of causing a computer built in a terminal device, comprising:
recognizing a reference object included in an input image,
determining whether feature information of the input image used for recognizing the reference object includes feature information based on free area information or non-free area information set in association with identification information of the recognized reference object, and
creating an image in which content associated with the identification information is superimposed on the input image based on a result of the determination.

7. A non-transitory, computer-readable recording medium having stored therein a program for causing a computer to execute a process, the process comprising:
recognizing a reference object included in an input image,
determining whether feature information of the input image used for recognizing the reference object includes feature information based on free area information or non-free area information set in association with identification information of the recognized reference object, and
creating an image in which content associated with the identification information is superimposed on the input image based on a result of the determination.
